(19) United States
(12) Patent Application Publication
(10) Pub. No.: US 2012/0090286 A1
(43) Pub. Date: Apr. 19, 2012

(54) FILTER ELEMENT

(76) Inventors: Kenichi FUJII, Ichikawa (JP); Hideaki Ishibashi, Ichikawa (JP); Yoshiko Fukui, Ichikawa (JP)

(21) Appl. No.: 13/272,652

(22) Filed: Oct. 13, 2011

(30) Foreign Application Priority Data
Oct. 16, 2010 (JP) 2010-233165

(51) Int. Cl. B01D 46/02; B01D 46/52

(52) U.S. Cl. 55/498

(57) ABSTRACT

A cylindrical pleated filter part is made from spunbond whose section is approximately star-shaped. Cylindrical soft joining materials are installed at an upper end portion and at a lower end portion of the pleated filter part respectively, and soft connecting materials intervene between the cylindrical soft joining materials and the cylindrical pleated filter part, respectively, in order to be able to remove the cylindrical pleated filter part of the filter element and dispose of it. Therefore, it becomes possible to install the filter element even if standard structures or sizes of various installation portions of bag filters or the like are different in some measure. A retainer part can be separated from the pleated filter part and reused, so disposal volume can be largely decreased and disposal costs can be decreased.

### BACKGROUND OF THE INVENTION

1. Field of the Invention

The present invention relates structure of a filter element used in a powder dust collection bag filter or the like, and is intended to plan versatility and reduction of the costs.

2. Explanation of Prior Arts

In various processes treating powder in a broad range of industries, many bag filters are used as applications such as collecting products or dust collection, but a request for downsizing of the filter is increased because of restriction of installation space. In the result, demand for a pleated filter which makes filtering area increase because the section of it is assumed approximately star and the surface of it is formed in a pleated shape is increased.

Regarding structure of the pleated filter part known until now, what is shown in FIG. 8 is known normally. In FIG. 8, this is a pleated filter part which is formed cylindrically wherein a mounting part 2 made from soft resin for fitting installation plate 3 onto an upper outer peripheral surface at upper end thereof and a bottom plate 4 made from resin are installed at a lower end thereof integrally, respectively.

Furthermore, a retainer part 5 made from resin is mounted integrally along the pleated filter 1 between the upper mounting part 2 and the bottom plate 4 and a reinforcing tape 6 is provided on an outer peripheral surface of the pleated filter part 1. However, because a general pleated filter part as above-mentioned has about 80° C. of heatproof temperature, what is illustrated in FIG. 9 is known as a pleated filter part with heatproof specification which is used under environment of about 200° C. which is higher temperature.

In the pleated filter part 1 formed cylindrically, a circular mounting part 7 made from metal is installed via heat proof resin 8 on an upper end edge thereof integrally and a bottom plate 10 made from metal is installed via heatproof resin 9 on a lower end edge thereof integrally. A mounting ring part 12 for holding a heatproof gasket 11 is formed downwardly under an outer peripheral surface side of the above-mentioned circular mounting part 7.

In the state that the mounting ring part 12 of the pleated filter part 1 via heatproof gasket 11 is maintained on the horizontal installation plate 3 and that one end of a L-letter-shaped clamp 13 whose another end is held on the mounting part 7 made from metal is maintained on the installation plate 3, the pleated filter part 1 is fixed on the installation plate 3 by passing an upper part of a bolt 14 standing on the horizontal installation plate 3 through L-letter-shaped clamp 13 and fixing a nut 15 to the upper part of the bolt 14 tightly.

Besides, in FIG. 9, a number 16 indicates a retainer part made from metal and a number 17 indicates a reinforcing tape.

Furthermore, for overall structure of a general bag filter, what comprises a plurality of bag filters which stand on a hopper for collecting dusts, a dust containing gas supplying piping for introducing dust containing gas into every bag filter via the hopper, cleaning gas piping for vacuuming cleaning gas passing through the bag filters and introducing piping for backwashing gas applying counter pressure to the bag filters is known (JP 2003-38922 A).

### SUMMARY OF THE INVENTION

However, in the above-mentioned prior filter element, molding processing takes time and further it cannot be avoided increasing cost. Especially, a rise of the production cost due to using expensive resin material and parts made from metal in the heatproof filter part cannot be avoided, so that applications are limited necessarily and it becomes the cause for preventing wide diffusion.

Furthermore, at replacement due to life duration of the filter, because whole filter element cannot but be discarded since it is molded integrally, not only filter costs at replacement of filter are increased, but also a rise of transportation costs, working costs, scrapping charge or the like required for scrapping cannot be avoided. Besides, it is remained as a problem to be solved also in an environmental pollution problem.

Moreover, since the filter element in the above-mentioned prior product is produced under an individual standard by each maker, the user cannot help purchasing the same filter element as what is installed initially, namely the same kind of filter of the same maker when the filter element is replaced due to filter life duration, absurdity such that the other company products which are inexpensive or have good efficiency of collecting dust cannot be used is present, especially in the case of the heatproof pleated filter, it is a present state that diffusion or spread is prevented due to high costs.

Therefore, in the present invention, for prior integral type of pleated filter element, the inventor focused attention on being able to solve almost of the above-mentioned problems if a part of the pleated filter can be separated from the retainer part by changing the integrally molding or structure of product, and further if parts such as a retainer part and the like except for the pleated filter part can be recycled.

In order to attach a cylindrical soft joining material onto an end part of the cylindrical pleated filter part whose section is approximately star-shaped, as a result of further device, the problem in this point could be solved by providing the soft connecting material deformed into a star-shape similar to the section of the above-mention pleated filter part.

Thus, the only pleated filter part can be removed from the retainer part and be replaced, and further the retainer part in the pleated filter part can be reusable as it is, and that, for the whole filter element, the filter element is to be able to attach to and use in many bag filter devices by being possible to let this filter element correspond to installation size of the other maker's filter element.

Concretely, the present invention relates to a filter element comprising a cylindrical pleated filter part whose section is approximately star-shaped, cylindrical soft joining materials attached to an upper end part and a lower end part of the pleated filter part respectively, and soft connecting material intervening between each of the cylindrical soft joining materials and the cylindrical pleated filter part. Besides, the present invention relates to a filter element that a porous cylindrical retainer part is inserted from the filter element removably onto an inner peripheral surface of the cylindrical pleated filter part whose section is approximately star-shaped.

Furthermore, the present invention relates to a filter element that a mesh cylindrical retainer part is inserted from the filter element removably onto an inner peripheral surface of the cylindrical pleated filter part whose section is approximately star-shaped. Moreover, the present invention relates to a filter element that a ring-shaped reinforcing material is mounted removably on an outer peripheral surface of the cylindrical pleated filter part whose section is approximately star-shaped.

As described above, for structure of the filter element, because the present invention comprises a cylindrical pleated filter part whose section is approximately star-shaped, cylindrical soft joining materials installed at an upper end portion and at a lower end portion of the pleated filter part respectively, and soft connecting material intervening between the cylindrical soft joining materials and the cylindrical pleated filter part respectively, resin materials for molding installed at the upper end portion and the lower end portion respectively were unnecessary and in the result, production costs and production duration could be decreased largely.

Besides, since the cylindrical retainer part is attached removably in an inner peripheral surface of the cylindrical pleated filter part whose section is approximately star-shaped, the retainer part in the inner peripheral thereof removes from the pleats filter part, only the pleated filter part and the cylindrical soft joining materials mounted at both ends of the pleated filter part are disposed, and the retainer part except for them can be reused, so that disposal volume can be decreased largely and decrease of disposal cost can be intended, and further it can contribute also in environmental program.

Furthermore, for the cylindrical soft joining materials installed at the upper end portion and the lower end portion of the pleated filter part, because they can be mounted by means of sewing, bonding or thermal fusion bonding with woven fabric, nonwoven fabric, the other soft sheet material or the like, they can be used in filter elements with different standards respectively, and in the result, the costs can be decreased largely and an advance in demand can be expected.

### BRIEF EXPLANATION OF THE DRAWINGS

FIG. 1 is a half vertical cross-section view showing a filter element with an abbreviated part which is one embodiment according to the present invention;

FIG. 2 is a cross-section view along the line A-A showing in FIG. 1;

FIG. 3 is a cross-section view along the line B-B showing in FIG. 1;

FIG. 4 is a cross-section view along the line C-C showing in FIG. 1;

FIG. 5 is a half vertical cross-section view showing one example of an installation state by means of screw-type band, of the filter element according to the present invention;

FIG. 6 is a half vertical cross-section view showing a progress that the filter element according to the present invention is installed from the upper end portion;

FIG. 7 is a cross-section view along the line X-X in FIG. 5 and FIG. 6;

FIG. 8 is a half vertical cross-section view showing typical structure of the prior filter element; and

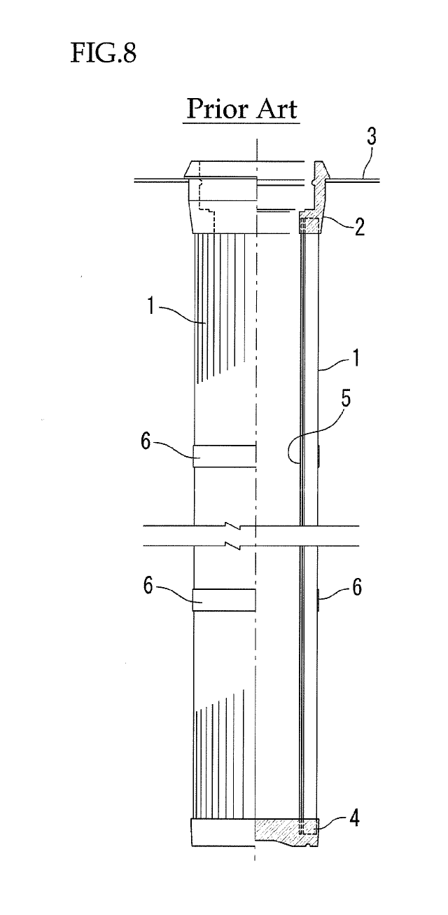

FIG. 9 is a half vertical cross-section view showing typical structure of the prior heatproof filter element.

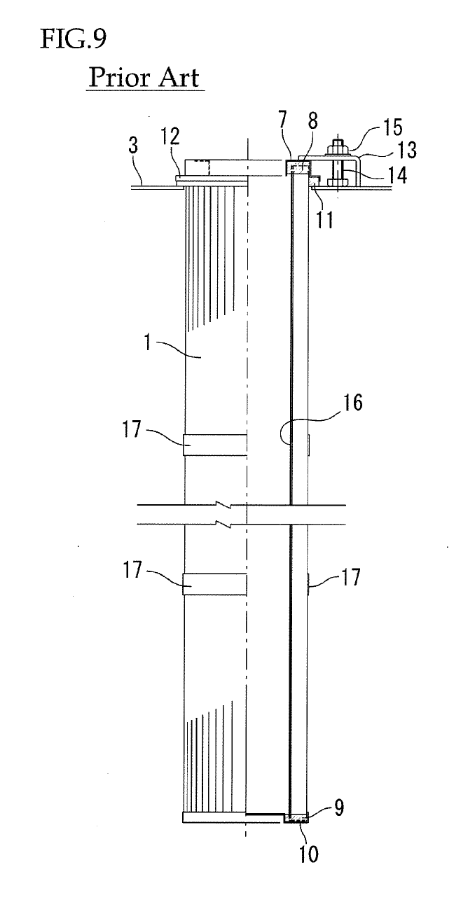

### EXPLANATION OF PREFERABLE EMBODIMENT

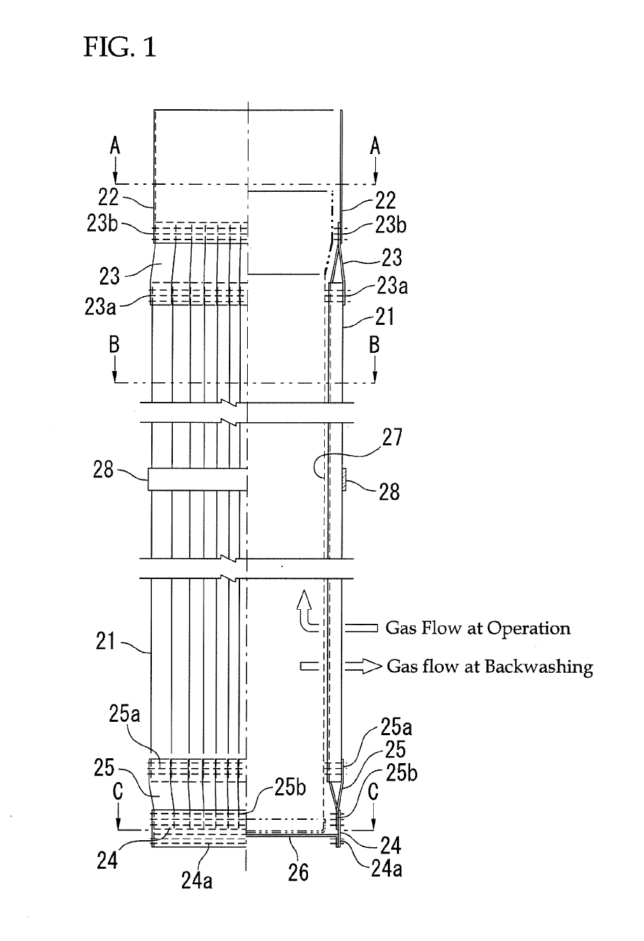

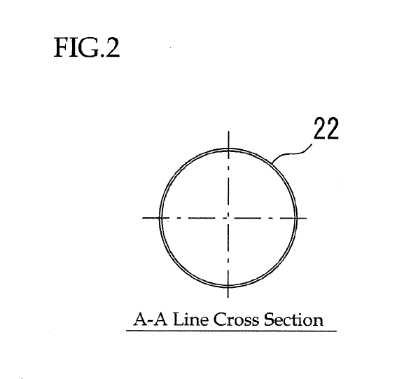

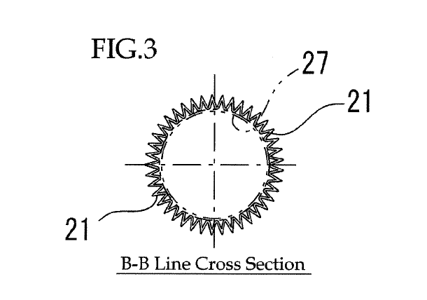

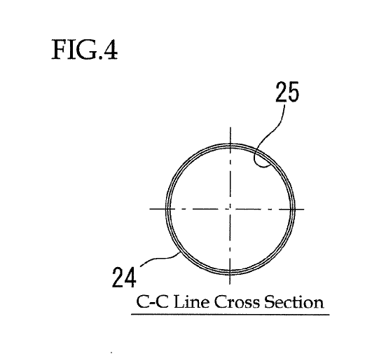

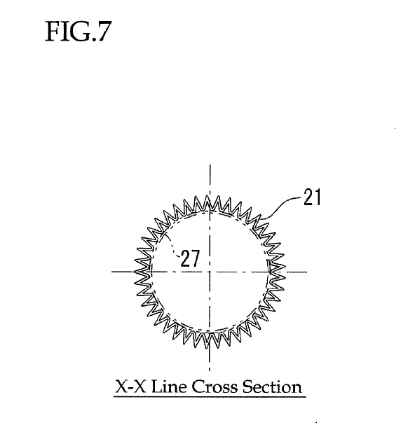

Hereinafter, a working mode of the present invention is explained in detail. In FIGS. 1 to 7, a number 21 indicates a pleated filter part, numbers 22 and 24 indicate soft joining material, a number 26 indicates a bottom material, a number 27 indicates a retainer part, and a number 28 indicates a ring-shaped reinforcing material. The pleated filter part 21 is preferably a fine porous material such as nonwoven fabric, woven fabric or the like, especially which is made from spunbond or curing felt, and it is formed like bellows by folding the material in turn alternately at constant intervals, and it becomes cylindrical by bonding both ends in a width direction thereof, and in the result, as shown in a cross-section of FIG. 3, it is constituted so that the cross-section of it becomes approximately star-shaped.

The soft joining materials 22 and 24 are cylindrical with diameters closer than the diameters of opening end edges of an upper end portion and a lower end portion of the cylindrical pleated filter part 21, and are constituted of fabric preferably, especially heatproof fabric or the like as the case, and further, an opening edge of one side (a lower side) of the soft joining material 22 is installed airtightly along an upper end opening edge of the pleated filter part 21 via a soft connecting material 23 by means of sewing, bonding, thermal fusion bonding or the like.

An opening edge of one side (an upper side) of the soft joining material 22 of the soft joining material 24 is installed airtightly along a lower end opening edge of the pleated filter part 21 via a soft connecting material 25 by means of sewing, bonding, thermal fusion bonding or the like. Besides, in drawings, a number indicates a bottom material installed airtightly along a circumferential direction on an another side (a lower side) of the soft joining material 24 by means of sewing, bonding, thermal fusion bonding or the like, and a soft material with a material similar to the soft joining material 24 shall be used in the bottom material 26.

The soft connecting materials 23 and 25 are approximately cylindrical with approximately similar diameters to the soft joining materials 22 and 24, and one side opening ends of them are installed to end portions of the soft joining materials 22 and 24 by means of sewing, bonding or thermal fusion bonding, and further, the soft connecting material 23 and 25 are formed so that their end surfaces are approximately star-shaped by gradually heightening projecting widths of groove portions like a V-letter-shape which are formed like bellows by folding them in turn alternately at constant intervals, so that they are constituted so as to be installed by means of sewing, bonding or thermal fusion bonding with meeting large portions (end portions) of the projecting widths to the star-shape of an end portion of the pleated filter part 21.

Furthermore, the retainer part 27 is a shape retaining material in an inner peripheral side of the pleated filter part 21, many relative large holes are formed in a surface of the retainer part 27 which is constituted like a basket with a bottom as a whole, and further the retainer part 27 is installed removably in the pleated filter part 21. Moreover, a ring-shaped reinforcing material 28 is a shape retaining material in an outer peripheral side of the pleated filter part 21 and constituted of a band-shaped annular material approximately similar to an outer diameter of the pleated filter part 21.

The pleated filter part 21 can be replaced easily by pulling pleated filter part 21 upward from the retainer part 27.

In the above-mentioned structure, the cylindrical soft joining material 24 is installed via the soft connecting material 25 on one side (a lower side) opening edge of the cylindrical pleated filter part 21 by means of sewing, bonding or thermal fusion bonding 25a-25b, and the bottom material 26 is installed at a lower end of the soft joining material 24.

Meanwhile, the cylindrical soft joining material 22 is installed also on the other side (an upper side) of the cylindrical pleated filter part 21 by putting the soft connecting material 23 between the cylindrical connecting material 22 and itself by means of sewing, bonding or thermal fusion bonding 23a-23b. Furthermore, the filter element is completed by installing the retainer part 27 from the upper opening part of the cylindrical soft joining material 22 along the inner peripheral side of the pleated filter part 21 to a position where a top end portion of the pleated filter part 21 reaches to the bottom material 26.

The completed filter element is installed at an installation position of a filter such as a bag filter or the like by the cylindrical soft joining material 22 which is positioned at an upper end thereof. In this case, because the soft joining material 22 is remarkably softer than the prior installation portion made from resin or the ring-shaped installation portion made from metal, it is possible to process it corresponding to a shape or a size of the installation position, and further it is possible to install it on the soft connecting material 23 by means of sewing, bonding, thermal fusion bonding or the like voluntarily.

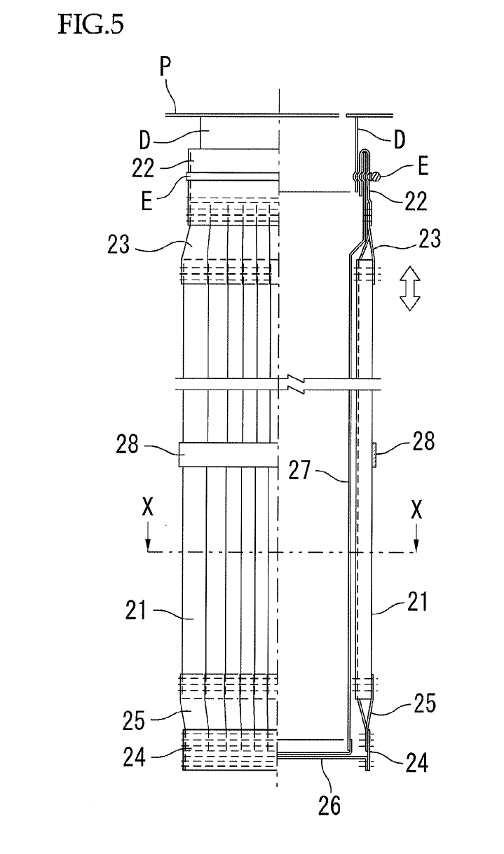

For concrete installation means, for instance, as shown in FIG. 5, an outer diameter of a cylindrical installation portion D of an installation plate P is a little smaller than one of the cylindrical soft joining material 22, and the cylindrical, soft joining material 22 is inlayed into the outer peripheral edge of the cylindrical installation portion D in the condition that seal ability is ensured by folding an upper part of the cylindrical soft joining material 22 inward and it can be tightened and secured by a tightening band E with a screw.

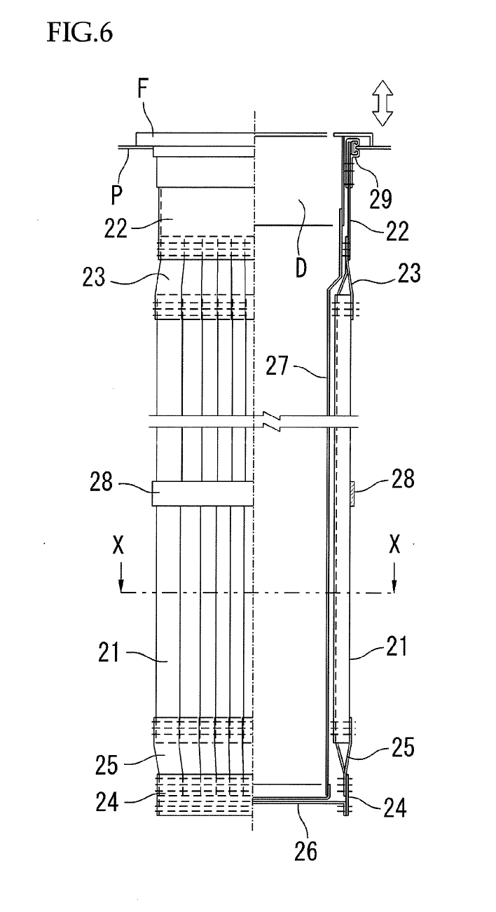

Furthermore, as shown in FIG. 6, a plate spring 29 of a sealing material setting on an upper end of the cylindrical joining material 22 preliminarily, the plate spring 29 of the sealing material is installed between a circular installation hole opened in the installation plate P and the cylindrical joining material 22, the plate spring 29 of the sealing material is inlaid between the circular installation hole opened in the installation plate P and the cylindrical joining material 22 to hold the cylindrical joining material 22 airtightly, and further the retainer part 27 is installed from upside of the installation plate P into the inner diameter side of the pleated filter part 21.

1. A filter element comprising a cylindrical pleated filter part made from spunbond whose section is approximately star-shaped, cylindrical soft joining materials installed at an upper end portion and at a lower end portion of said pleated filter part respectively, and soft connecting materials intervening between said cylindrical soft joining materials and said cylindrical pleated filter part respectively.

2. A filter element comprising a cylindrical pleated filter part made from curing felt whose section is approximately star-shaped, cylindrical soft joining materials installed at an upper end portion and at a lower end portion of said pleated filter part respectively, and soft connecting materials intervening between said cylindrical soft joining materials and said cylindrical pleated filter part respectively.

3. A filter element according to claim 1, wherein a porous cylindrical retainer part is installed removably to said cylindrical pleated filter part on an inner peripheral surface of the pleated filter part whose section is approximately star-shaped.

4. A filter element according to claim 2, wherein a porous cylindrical retainer part is installed removably to said cylindrical pleated filter part on an inner peripheral surface of the pleated filter part whose section is approximately star-shaped.

5. A filter element according to claim 1, wherein a mesh cylindrical retainer part is installed removably to said cylindrical pleated filter part on an inner peripheral surface of the pleated filter part whose section is approximately star-shaped.

6. A filter element according to claim 2, wherein a mesh cylindrical retainer part is installed removably to said cylindrical pleated filter part on an inner peripheral surface of the pleated filter part whose section is approximately star-shaped.
